(19) United States
(12) Patent Application Publication
(10) Pub. No.: US 2024/0303695 A1
(43) Pub. Date: Sep. 12, 2024

(54) APPARATUSES AND METHODS FOR TARGETED ADVERTISING BASED ON IDENTIFIED MISSING JOB QUALIFICATIONS

(71) Applicant: MY JOB MATCHER, INC. D/B/A JOB.COM, Austin, TX (US)

(72) Inventor: Arran Stewart, Austin, TX (US)

(73) Assignee: MY JOB MATCHER, INC. D/B/A JOB.COM, AUSTIN, TX (US)

(21) Appl. No.: 18/119,940

(22) Filed: Mar. 10, 2023

(51) Int. Cl. G06Q 30/0251; G06Q 50/20

(52) U.S. Cl. CPC G06Q 30/0269; G06Q 50/2057

(57) ABSTRACT

An apparatus for targeted advertising based on identified missing job qualifications is presented. The apparatus includes at least a processor and a memory communicatively connected to the at least a processor. The memory contains instructions configuring the at least a processor to receive a candidate datum containing a plurality of user identifiers describing a user, assign a user weight to each user identifier of the candidate datum, compute a score for each user identifier based on the user weight using a user score classifier, generate a candidate score datum as a function of the scores, and provide a targeted data transmission based on the candidate score datum and a posting score datum, wherein the targeted data transmission includes an educational posting.

### FIELD OF THE INVENTION

The present invention generally relates to the field of targeted advertising. In particular, the present invention is directed to apparatus and methods for targeted advertising based on identified missing job qualifications.

### BACKGROUND

Staffing and recruiting tools bridge the gap between job seekers and employers to find each other. Search engines enable each party to find one another based on specific preferences. However, often job seekers and employers are often bombarded with tangentially irrelevant search results, or the means for job seekers to improve their marketability to the employers

### SUMMARY OF THE DISCLOSURE

In an aspect, an apparatus for targeted advertising based on identified missing job qualifications is presented. The apparatus includes at least a processor and a memory communicatively connected to the at least a processor. The memory contains instructions configuring the at least a processor to receive a candidate datum, wherein the candidate datum contains a plurality of user identifiers describing a user, assign a user weight to each user identifier of the candidate datum, compute a score for each user identifier based on the user weight using a user score classifier, generate a candidate score datum as a function of the scores, wherein the candidate score datum includes a user activity score based on a user interaction data of the user and a candidate ranking, wherein the candidate ranking is relative to a plurality of candidate score datums of other users from a user database, and provide a targeted data transmission based on the candidate score datum and a posting score datum, wherein the targeted data transmission includes an educational posting.

In another aspect, a method for targeted advertising based on identified missing job qualifications is presented. The method includes receiving, by at least a processor connected to a memory containing instructions for the at least a processor, a candidate datum containing a plurality of user identifiers describing a user, assigning a user weight to each user identifier of the candidate datum, computing a score for each user identifier based on the user weight using a user score classifier, generating a candidate score datum as a function of the scores, wherein the candidate score datum includes a user activity score based on a user interaction data of the user and a candidate ranking, wherein the candidate ranking is relative to a plurality of candidate score datums of other users from a user database, and providing a targeted data transmission based on the candidate score datum and a posting score datum, wherein the targeted data transmission includes an educational posting.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for targeted advertising based on identified missing job qualifications;

FIG. 2 is a block diagram of an apparatus for targeted advertising based on identified missing job qualifications according to an embodiment of the present invention;

FIG. 3 is a block diagram of an apparatus for targeted advertising based on identified missing job qualifications according to another embodiment of the present invention;

FIG. 4 is a graph illustrating an exemplary relationship between fuzzy sets;

FIG. 5 is a block diagram of an exemplary embodiment of a cryptographic accumulator;

FIG. 6 is a diagrammatic representation of an exemplary embodiment of a neural network;

FIG. 7 is a diagrammatic representation of an exemplary embodiment of a node of a neural network;

FIG. 8 is a flow diagram of an exemplary embodiment of a method for targeted advertising based on identified missing job qualifications;

FIG. 9 is a block diagram of an exemplary embodiment of a machine-learning model; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for targeted advertising based on identified missing job qualifications. In an embodiment, the apparatus can receive a job seeker's information such as a resume and credentials. The apparatus may analyze the resume and its elements and parse them into various categories of skills, backgrounds, education, locations, or the like thereof, and score each of them. In another embodiment, the apparatus can rank a job seeker's resume among a plurality of resumes from other job seekers, wherein resume data is stored in a user database. The apparatus may also assign a weight to each element of a resume or compute a weighted average based on the frequency of certain strings and/or terms found in a resume, wherein the weight may be used by a matching module to identify a set of postings based on the weight. For instance, a resume may include multiple work experiences as a software engineer, in which the apparatus may identify postings for software engineering jobs to the user.

Aspects of the present disclosure can also be used to receive user queries. In an embodiment, a user may utilize a search engine incorporated with the apparatus to specify the type of job postings the user wishes to seek. The apparatus may assign a weight to keywords found in a user query based on the frequency of such keywords from similar queries by that user. The apparatus may also rank the keyword or each keyword in the user query to identify job postings based on the score and ranking. In another embodiment, the apparatus may assign weights to the keywords of a query and the elements of a resume relative to each other. For instance, a resume may indicate a job seeker has experience in data science, but the job seeker's query in the search engine of the apparatus may include keywords such as “software engineer.” The apparatus may assign a greater weight to the “software engineer” keyword compared to the weight for the job seeker's resume a data science experience and perform a search for job postings related to software engineering. In an embodiment, the apparatus may identify job postings based on similarities found in the strings and/or terms found in the job seeker's resume and query.

Aspects of the present disclosure can also be used to rank a plurality of job postings. In an embodiment, the apparatus may implement a user interface and a database containing a plurality of job postings entered by employers. The apparats may rank each posting relative to each other using machine-learning and artificial intelligence. The apparatus may also parse each job posting and compute scores for each element of the posting such as specific job duties, requirements, relevant experiences, or the like thereof. The apparatus may also present to a job seeker with job postings with similar scores and/or rankings to that of the job seeker and its resume/query.

Aspects of the present disclosure can also be used to identify missing qualifications in a job seeker's resume. In an embodiment, the apparatus may score a plurality of elements in a job seeker's resume such as skills for a specific job type. The apparatus may compare the job seeker's resume to a set of job postings found based on the job seeker's resume and/or the job seeker's query to find any missing qualifications that the job seeker may have for the set of job postings. In an embodiment, the apparatus may detect missing qualifications based on an overall score of the job seeker's resume being below the score of the job postings. For instance, the apparatus may identify the type of job posting that a job seeker is looking for based on the job seeker's resume and/or query. The apparatus may match general job requirements of that type of job posting to identify any missing qualifications, underperforming qualifications, or the like thereof. In another embodiment, the apparatus may select a set of job postings to the job seeker that best matches the job seeker's resume and qualifications based on the job seeker's resume ranking and/or score. This is so, at least in part, to provide the job seeker with job postings with the highest potential of success for the job seeker and the job posting while mitigating the amount of underqualified job seekers from applying to job postings with much greater scores.

Aspects of the present disclosure can be used to provide a plurality of postings to improve a job seeker's resume. In an embodiment, the apparatus may provide educational articles, courses, certificates, advertisements, or the like thereof, that may improve the job seeker's resume in increasing the job seeker's probability in finding success with a job posting that the job seeker is underqualified for. In another embodiment, the apparatus may score each posting based on interaction data associated with the posting, such as level of activity, number of clicks, level of user interaction with the posting, or the like thereof. The apparatus may also track the updates of other job seekers based on such postings, thereby scoring the postings if the job seekers improved their ranking and/or score as a result of the postings. For instance, a job seeker may have bolstered its resume after completing an online course or was offered a job as a function of the online course. The apparatus may increase the score of that educational posting as a result of its impact on other job seekers. In another embodiment, the apparatus may also update the ranking and/or score of the job seeker after completing the educational posting. In some embodiments, the apparatus may not be limited to educational postings, but other job postings that may serve as a steppingstone to enable a job seeker to qualify for a once underqualified job posting.

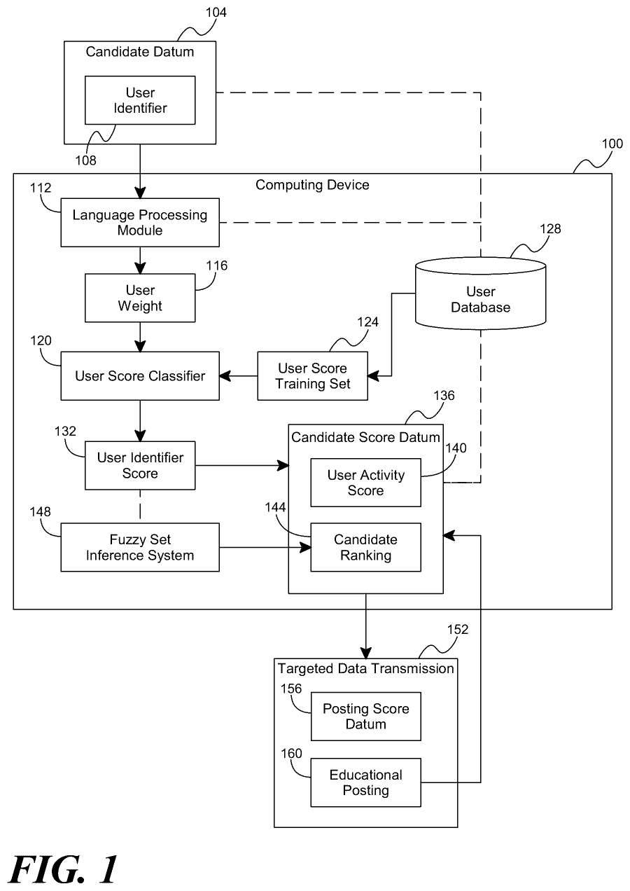

Referring now to FIG. 1, an exemplary embodiment of an apparatus for targeted advertising based on identified missing job qualifications is illustrated. The apparatus includes a computing device 100. computing device 100 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. computing device 100 may include a single computing device operating independently, or may include two or more computing device operating in concert, in parallel, sequentially or the like; two or more computing devices may be included together in a single computing device or in two or more computing devices. computing device 100 may interface or communicate with one or more additional devices as described below in further detail via a network interface device. Network interface device may be utilized for connecting computing device 100 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. computing device 100 may include but is not limited to, for example, a computing device or cluster of computing devices in a first location and a second computing device or cluster of computing devices in a second location. computing device 100 may include one or more computing devices dedicated to data storage, security, distribution of traffic for load balancing, and the like. computing device 100 may distribute one or more computing tasks as described below across a plurality of computing devices of computing device, which may operate in parallel, in series, redundantly, or in any other manner used for distribution of tasks or memory between computing devices. computing device 100 may be implemented using a “shared nothing” architecture in which data is cached at the worker, in an embodiment, this may enable scalability of system 100 and/or computing device.

With continued reference to FIG. 1, computing device 100 may be designed and/or configured to perform any method, method step, or sequence of method steps in any embodiment described in this disclosure, in any order and with any degree of repetition. For instance, computing device 100 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 100 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 100 includes a memory and at least a processor. The memory may include any memory as described in this disclosure. The memory may be communicatively connected to the at least a processor. As used in this disclosure, “communicatively connected” means connected by way of a connection, attachment or linkage between two or more relate which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. The memory may be configured to provide instructions to the at least a processor, which may include any processor as described in this disclosure.

With continued reference to FIG. 1, computing device 100 may operate a server and/or network enabling a plurality of computing devices to connect with each other on an online website. For instance, the online website may include a plurality of digital postings containing employment information about jobs, companies, professionals, job seekers, recruiters, or the like thereof. A “posting,” as used in this disclosure, is any digital piece of information, writing, image, and/or any item of content published online. For example and without limitation, a posting may include a job opening, article, hyperlink, educational courses, lectures, social media posts, or the like thereof. The online website may also include an interface for users operating the computing devices in the network to view a plurality of articles, interviews, videos, courses, or the like thereof. Person of ordinary skill in the art, upon reviewing the entirety of this disclosure, will be aware of the various embodiments of an online platform in the context of recruitment and staffing.

With continued reference to FIG. 1, computing device 100, receive a candidate datum 104 describing a user. A “user,” as used in this disclosure, is any entity seeking an employment that interacts with a computing device. In some non-limiting embodiments, a user may include a job seeker, candidate, employee, or the like thereof. A “candidate datum,” as used in this disclosure, is a candidate's personal information and/or attributes relevant to education, employment, activities, and the like thereof. In a non-limiting embodiment, candidate datum 104 may include a resume, CV, or the like thereof. Candidate datum 104 may include specific candidate information such as employment history, employment duties and responsibilities, education, credentials, area of residence, contact information, age, hobbies and interests, certifications, or combination thereof. In another non-limiting embodiment, the specific candidate information may further include candidate's prior record, personal address, social security number, phone number, experience level, acquired skills, geographical location, expected compensation, job performance acknowledgements (e.g., awards, honors, distinguishments), photograph of user, sample work product, and the like thereof. Person of ordinary skill in the art, upon reviewing the entirety of this disclosure, will be aware of the various embodiments of user personal information in the context of job seeking.

With continued reference to FIG. 1, computing device 100 may receive candidate datum 104 directly from a user, database, third-party application, remote device, immutable sequential listing, social media profile, or the like thereof. In some non-limiting embodiments, computing device 100 may generate a candidate profile for the user based on candidate datum 104. A “candidate profile,” as used in this disclosure, is a digital representation of a candidate containing candidate datum for the public viewing of an audience such as other job seekers and employers. In some non-limiting embodiments, a candidate profile may include a digital avatar, digital poster, digital advertisement, digital summary of the candidate, and the like thereof. In another non-limiting embodiment, the candidate profile may include a profile image, username, name of any group and/or club that the candidate is associated with, and the like thereof. Computing device 100 may enable a user to create their own candidate profile to be displayed. Person of ordinary skill in the art, upon reviewing the entirety of this disclosure, will be aware of the various embodiments of a digital representation of a candidate in the context of employment recruitment.

With continued reference to FIG. 1, candidate datum 104 includes a user identifier 108. A “user identifier,” as used in this disclosure is information representing a user and/or candidate that are relevant to employment recruiting entities such as employers, job postings, job listings, job advertisements, or the like thereof. Candidate datum 104 may include a plurality of user identifiers 108. In a non-limiting embodiment, user identifier 108 may include text strings describing candidate information. For example and without limitation, user identifier 108 may include name, contact information, resume, previous work history, cover letter, profile photo, a list of relevant skills, certifications, and the like. In another non-limiting example, user identifier 108 may include information representing a user such as skills, competencies, experience, credentials, talents, or the combination thereof. For instance, specific information regarding skills can include “back-end software development,” “front-end software development,” full-stack,” “quality assurance,” “attention to detail,” “object-oriented programming,” “machine-learning,” and the like thereof. Person of ordinary skill in the art, upon reviewing the entirety of this disclosure, will be aware of highlighting terms and/or the various types of skills, functions, duties, and/or qualifications associated with a candidate that are relevant to potential employers, recruiters, hiring managers, and the like thereof.

With continued reference to FIG. 1, computing device 100 may store and/or retrieve any candidate datum 104, candidate profile, and/or user identifier 108 in user database 128. A “user database,” as used in this disclosure, is a resource storage system used to collect and store any information received from a user and/or candidate, such as videos, images, documents, and the like. User database 128 may be implemented, without limitation, as a relational database, a key-value retrieval database such as a NOSQL database, or any other format or structure for use as a database that a person skilled in the art would recognize as suitable upon review of the entirety of this disclosure. User database 128 may alternatively or additionally be implemented using a distributed data storage protocol and/or data structure, such as a distributed hash table or the like. User database 128 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, computing device 100 may receive candidate datum 104 and parse it using a language processing module 112. A “language processing module,” as used in this disclosure, is any hardware and/or software module used to extract, from the one or more documents, files, datum, strings, texts, terms, or the like thereof. For instance and without limitation, language processing module 112 may be consistent with the language processing module in U.S. patent application Ser. No. 17/667,651, and entitled, “APPARATUSES AND METHODS FOR CLASSIFYING A USER TO A POSTING,” which is incorporated by reference herein in its entirety. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

In some non-limiting embodiments and still referring to FIG. 1, language processing module 112 may include a program automatically generated by computing device 100 and/or language processing module 112 to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at processor 104 and/or computing device 112, or the like.

In another non-limiting embodiment and still referring to FIG. 1, language processing module 112 and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Experience-Bayes (NB), Stochastic Gradient Descent (SGD), and parameter grid-searching classification techniques; the result may include a classification algorithm that returns ranked associations. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, computing device 100 is configured to assign a user weight 116 to each user identifier 108 of candidate datum 104. A “user weight,” as used in this disclosure, is a calculation that considers varying degrees of importance of a user identifier in a candidate datum. In a non-limiting embodiment, user weight 116 may be represented as a numerical value, percentage, ratio, symbol, or the like thereof. User weight 116 may be calculated based on the results of language processing module 112. In a non-limiting embodiment, computing device 100 and/or language processing model 112 may detect a higher frequency of a user identifier describing certain job duties, functions, responsibilities, roles, or the like thereof. For instance, candidate datum 104 may include multiple instances of “web development.” This may be detected by language processing module 112, in which a user weight for “web development” may be higher and/or heavier than other terms. In some non-limiting embodiments, computing device 100 may use user weights 116 to determine an overall score for the candidate of which candidate datum 104 is derived from. Person of ordinary skill in the art, upon reviewing the entirety of this disclosure, will be aware of the various embodiments and function so calculating varying degrees of importance in a candidate's information in the context of staffing and recruiting.

With continued reference to FIG. 1, computing device 100 is configured to compute a score such as a user identifier score 132 for each user identifier 108 based on user weight using a user score classifier 120. A “user identifier score,” as used in this disclosure is a quantitative symbol grading a candidate and its candidate datum based on a grading metric. The grading metric can include certain threshold, values, minimum requirements, and/or standard rubric. In some non-limiting embodiments, computing device 100 may compute a score based on other candidate datums from user database 128. User identifier score 132 may include a grade, rating, percentage, percentile, value, or the like thereof, indicating a level of proficiency, preferability, and/or probability of success for each user identifier 108. For instance, computing device 100 may compute a score and/or grade of “AAA” for a candidate with 25 or more years of experience in software engineering, denoting that the candidate is an expert. Computing device 100 may compute a score of “BBB” for a candidate's proficiency skill in “C++” programming language based on the frequency of the skill “C++” in the candidate datum, years of experience using “C++,” certifications in “C++,” or the like thereof, wherein the “BBB” score is computed indicating that the candidate is a professional but not an exceptional expert. In another example, computing device 100 may compute a score of “CCC” for a user identifier of a candidates age such as 50 years old, indicating that this age is not ideal for job seeking. Person of ordinary skill in the art, upon reviewing the entirety of this disclosure, will be aware of the various scores and/or grades for various elements of a candidate's information in the context of staffing and recruiting.

With continued reference to FIG. 1, a “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Computing device 104 and/or another device may generate a classifier using a classification algorithm, defined as a processes whereby a computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, computing device 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, a “user score classifier,” as used in this disclosure, is any classifier, machine-learning model, process, algorithm, or the like thereof, used to receive a candidate datum and/or user weight(s) to output a user identifier score. In a non-limiting embodiment, computing device 100 may train user score classifier 120 using a user score training set 124. A “user score training set,” as used in this disclosure, is a training data and/or set including an identifier significance correlated to a predictive score. An “identifier significance,” as used in this disclosure, is a quantifier of importance, frequency, or priority of a user identifier. A “predictive score,” as used in this disclosure, is a score related to a user identifier and its likelihood of matching with certain job postings based on the job postings' scores. In some non-limiting embodiments, user score training set 124 may be retrieved from user database 128. Computing device 100 may train use score classifier 120 with user score training set 124 to output user identifier score 132. Person of ordinary skill in the art, upon reviewing the entirety of this disclosure, will be aware of the various embodiments of computing a score in the context of machine-learning.

With continued reference to FIG. 1, computing device 100 is further configured to generate a candidate score datum 136 as a function of the user identifier score 132. A “candidate score datum,” as used in this disclosure, is a collection of information containing a summary of user identifier scores and an overall score/ranking of a candidate and its candidate datum, candidate profile, or the like thereof. In some non-limiting embodiments, candidate score datum 136 may include a plurality of user identifier scores 132 associated with each user identifier 108. Candidate score datum 136 may include a report of a candidate's resume and/or profile. Candidate score datum 136 may include a quantitative metric indicating a rating and/or grade of a candidate's profile. For example and without limitation, computing device 100 may compute a completion percentage of 70%, indicating that a candidate has not provided 30% of various useful information that may bolster that candidate's profile. In another non-limiting example, candidate score datum 136 may include a visual infographic of scores displayed to viewers, indicating which aspects of a candidate's resume and/or skills are strong, weak, mediocre, missing, or the like thereof. Person of ordinary skill in the art, upon reviewing the entirety of this disclosure, will be aware of the various embodiments of a report and/or visual in the context of displaying scores.

With continued reference to FIG. 1, candidate score datum 136 contains a user activity score 140 based on a user interaction data. A “user activity score,” as used in this disclosure, is any score and/or indicator describing the level of online presence a candidate has. For instance, a candidate that is actively interacting with computing device 100 and/or the online website backed by computing device 100 may be given a higher user activity score 140. Computing device 100 may provide candidates with higher user activity scores 140 with targeted advertisements to enable efficient online interactions. A “user interaction data,” as used in this disclosure, is information indicating interactive elements of a user. For example and without limitation, user interaction data may include the frequency of a candidate connecting to the network and/or server of computing device 100, number of clicks on a website, number of clicks on a link, time online, interactions with other users, or the like thereof. In a non-limiting embodiment, user interaction data may include any quantifiable data indicating the intensity of which a user is online and interacting with the apparatus as disclosed in the entirety of this disclosure. Person of ordinary skill in the art, upon reviewing the entirety of this disclosure, will be aware of the various embodiments of interactions in the context of determining user activity.

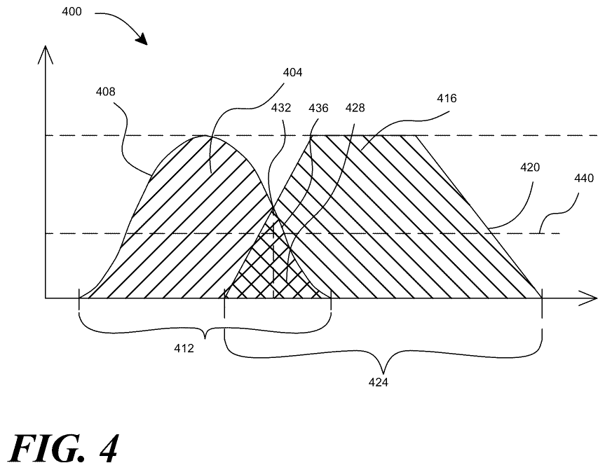

With continued reference to FIG. 1, candidate score datum 136 contains a candidate ranking 144. A “candidate ranking,” as used in this disclosure, is a value of order within a grading system indicating a level of best to worst candidates, candidate datums, and/or candidate profiles. Candidate ranking 144 may include a symbol, number, value, percentage, or the like thereof, indicating a candidate's ranking among a plurality of candidates in user database 128. In some non-limiting embodiments, computing device 100 may group candidates based on several tiers for organization purposes. In a non-limiting embodiment, computing device 100 may update candidate ranking 144 based on a user's interaction data. For instance, users that are active may have their rankings improved to prioritize candidates that are actively job seeking compared to those that are not. In some non-limiting embodiments, candidate ranking 144 may be generated using a fuzzy set inference system 148. A “fuzzy set inference system,” as used in this disclosure, is a metric system used to classify user identifiers into various ranking levels based on a degree of membership of the user identifiers between each other. For example, “John Smith” may be ranked higher than “Jane Doe” based on a determination that Smith's resume is superior to Doe's based on the high compatibility of Smith's resume to a job posting. In some embodiments, compatibility may be based on the similarity of keywords in user identifier 108 to keywords contained in a posting. In some embodiments, compatibly may be based on the total amount of similar keywords contained in user identifier 108. In some embodiments, compatibility may be the quality of keywords found in user identifier 108, for example, Smith's resume may contain keywords that are prioritized higher than the keywords contained in Doe's. Ranking the plurality of user identifiers 108 includes using a fuzzy set inference system 148, wherein fuzzy set inference system 148 is further described in FIG. 4. In some non-limiting embodiments, computing device 100 may take the output data of user score classifier 120 such as user identifier score 132 and use it as a fuzzy set input wherein fuzzy set inference system 148 may utilize a superiority criterion to rank each matched user identifier against that the plurality of matched user identifiers 108. For instance and without limitation, superiority criterion may be consistent with the superiority criterion in U.S. patent application Ser. No. 17/667,651. Person of ordinary skill in the art, upon reviewing the entirety of this disclosure, will be aware of the various embodiments of ranking a plurality of candidates in the context of staffing and recruiting.

With continued reference to FIG. 1, computing device 100 is further configured to provide a targeted data transmission 152 based on candidate score datum 136 and a posting score datum 156. A “targeted data transmission,” as used in this disclosure, is a transmission containing beneficial information to a candidate based on the information available and the candidate's statistics or preferences. In a non-limiting embodiment, targeted data transmission 152 may include a curated advertisement to be provide to a candidate based on the candidate's resume, work experience, work history, preferences, or the like thereof, identified and/or parsed by computing device 100 and/or language processing module 112. In some non-limiting embodiments, the advertisements found in targeted data transmission may include promoted job postings, job listings, job openings, relevant articles, relevant hiring managers and/or recruiters, relevant professionals, or the like thereof. Targeted data transmission 152 is further selected based on posting score datum 156. A “posting score datum,” as used in this disclosure is a quantifier of a position or level regarding the quality of a posting. For instance, posting score datum 156 may include any score as described herein associated with a posting. In some non-limiting embodiments, computing device 100 may compare a posting score datum of a posting to a user identifier score and/or average user identifier score of a candidate datum as found in a candidate score datum to generate a targeted data transmission containing a posting best matched with the candidate. For instance, a candidate with a resume indicating that the candidate is an entry level professional in software engineering may be identified by the computing device, in which the computing device may compile a plurality of postings such as job openings of other entry level software engineering positions, articles for assisting entry level software engineers, hiring managers seeking entry level software engineers, or the like thereof. Each posting may be associated with a score wherein the computing device may select postings with a similar score to that of a candidate. In a non-limiting embodiment, computing device 100 may provide targeted data transmission 152 as a notification. A “notification,” as used in this disclosure, is an information delivery made to be available to a candidate in a sensory form. In some non-limiting embodiments, a notification may be embodied as a pop-up window, auditory ping, text box, reminder, or the like thereof. Computing device 100 may continuously provide notifications as new or other relevant postings are identified. Person of ordinary skill in the art, upon reviewing the entirety of this disclosure, will be aware of the various embodiments of a computing device compiling relevant digital postings based on a candidate in the context of staffing and recruiting.

With continued reference to FIG. 1, targeted data transmission 152 contains an educational posting 160. An “educational posting,” as used in this disclosure, is a posting containing a relevant educational piece of information to a candidate. In some non-limiting embodiments, educational posting 160 can include promotions such as informational articles, social media posts, certification, online course, advertisements from relevant professional coaches, or the like thereof. In another non-limiting embodiment, computing device 100 may compile postings related to jobs that are different to that of a candidate. For instance, computing device 100 may provide educational postings for jobs in other fields that the candidate may wish to switch into. This may be identified from other candidates with similar work experience in the same field as candidate that have switched to various fields of work. In another embodiment, computing device 100 may collect information based on other candidates and their interaction data that indicate a career switch. For example and without limitation, some candidates who were employed as a data analyst may have switched into software engineering roles. Such candidates may have interacted with various postings related to career shifts from data analysts to software engineering. Computing device 100 may record these interactions from the clicks such postings generate and/or where such clicks originate from. Person of ordinary skill in the art, upon reviewing the entirety of this disclosure, will be aware of the various embodiments of compiling useful advertisement in the context of user interaction and behavior.

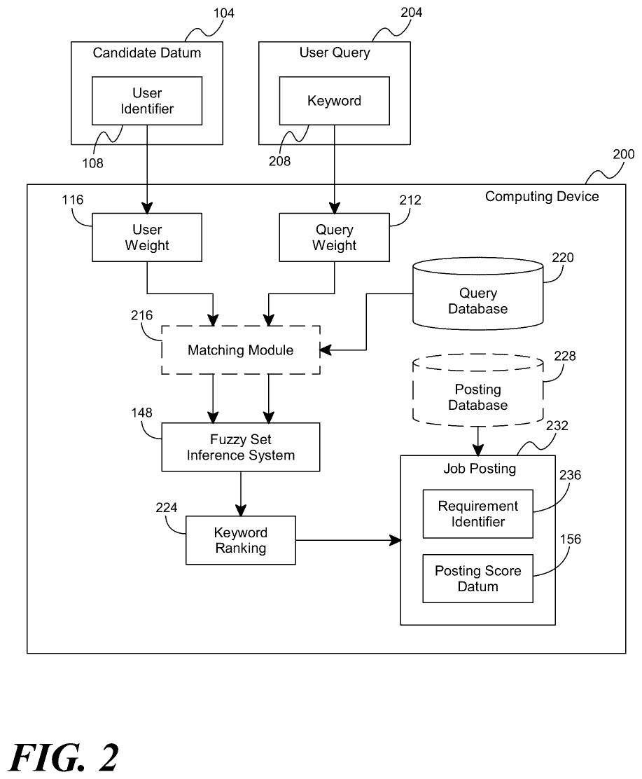

Referring now to FIG. 2, a block diagram of an apparatus for targeted advertising based on identified missing job qualifications according to an embodiment of the present invention is illustrated. In a non-limiting embodiment, computing device 200 may receive a user query 204 from a user and/or candidate. Computing device 200 may be consistent with any computing device as described herein. A “user query,” as used in this disclosure, is a string of keywords entered into a search engine to satisfy a user's employment seeking needs. User query 204 may include strings describing texts or phrases indicative of potential employment types, employment fields, employment positions, or the like thereof. User query 204 may contain a keyword 208. User query 204 may include a plurality of input boxes. User query 204 may enable a candidate to enter a plurality of job titles, positions, skills, requirements, locations, and the like thereof, in which computing device 200 may parse them and provide a targeted data transmission based on the priority of each entry. A “keyword,” as used in this disclosure, is a set of strings identifying a word or phrase describing a job preference quality that are used to be recognized by a computing device. A “job preference quality,” as used in this disclosure, is a search factor related to employment or careers. In some non-limiting embodiments, the keywords entered as a query may be distinct from that of a general search engine, wherein the apparatus of the disclosure incorporates a search engine targeted for identifying postings exclusively related to employment and/or recruiting. In some non-limiting embodiments, keyword 208 may include a specific role such as “software engineer,” “business analyst,” “consultant,” or the like thereof. User query 204 may contain a plurality of keywords 208, wherein a language processing module may parse user query 204 to distinguish each keyword 208 in user query 204. Person of ordinary skill in the art, upon reviewing the entirety of this disclosure, will be aware of the various embodiments of search terms or phrases that may be entered in the context of search engine.

With continued reference to FIG. 2, computing device 200 may be configured to assign a query weight 212 based on the user query 212 and/or keyword 208. A “query weight,” as used in this disclosure, is a calculation that considers varying degrees of importance of one or more keywords in a user query. In a non-limiting embodiment, query weight 212 may include any weight as described herein and may be represented as a numerical value, percentage, ratio, symbol, or the like thereof. In a non-limiting embodiment, query weight 212 may be calculated based on the results of language processing module such as language processing module 112. In a non-limiting embodiment, computing device 200 and/or language processing model 112 may detect a higher frequency of a keyword describing a job preference quality such as certain job duties, functions, responsibilities, roles, or the like thereof. Computing device 200 may determine such frequencies based on a plurality of queries recorded in a query database 200. A “query database,” as used in this disclosure, is any database used to store user inputs such as user queries. Query database 220 may include any database as described herein.

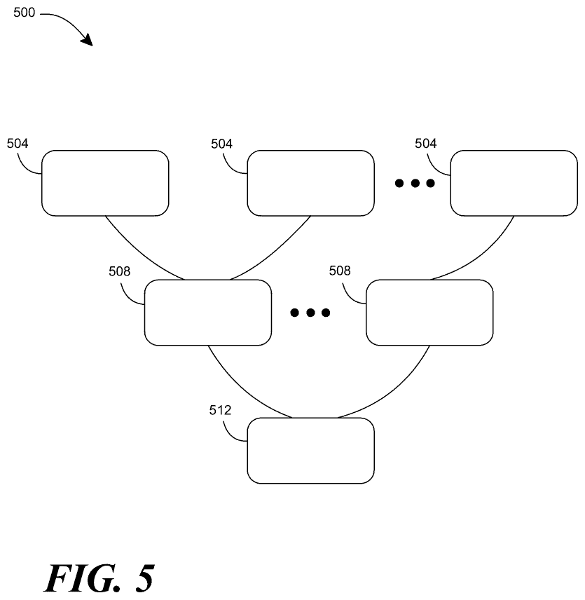

With continued reference to FIG. 2, computing device 200 may match keywords 208 to user identifiers 108. In some non-limiting embodiments, computing device 200 may use a matching module 216 to match keywords 208 to user identifiers 108. A “matching module,” as used in this disclosure, is any hardware/software used to compare a plurality of data to each other. In some non-limiting embodiments, matching module 216 may take user weights 116 and/or query weights 212 as inputs. For instance, based on the weights, matching module 216 may determine of a match is closely related or leaned to one side or the other from the inputted keywords 208 and/or user identifiers 108. For example, a candidate may include a resume that computing device 200 may identify that the candidate is a “data analyst,” while the user query contains “software engineer” keywords. Computing device 200 may place a greater weight for user query 204 than candidate datum 104, thereby instructing matching module 216 to consider the heavier weight of query weight 212 associated with the “software engineer” keyword. This is so, at least in part, to compute a ranking for the “software engineer” keyword to compile a set of job postings 232 that may be provided to the candidate. In some non-limiting embodiments, matching module 216 perform the matches using a cryptographic accumulator as further described in FIG. 5. Person of ordinary skill in the art, upon reviewing the entirety of this disclosure, will be aware of the various embodiments of matching a candidate's resume with their preferences denoted by the user query in the context of search engines.

With continued reference to FIG. 2, computing device 200 may generate a keyword ranking 224 based on a plurality of weighted values such as query weight 212 and/or user weight 116 based on the frequency of each keyword 208 from a query database 220. A “keyword ranking,” as used in this disclosure, is a value of order within a grading system indicating a level of priority for keywords. In a non-limiting embodiment, keyword ranking 224 may include a symbol, number, value, percentage, or the like thereof, indicating a keyword's ranking among a plurality of keywords in query database 220. In some non-limiting embodiments, computing device 200 may group keywords based on several tiers for organization purposes. In a non-limiting embodiment, computing device 200 may use fuzzy set inference system 148 to determine keyword ranking 224. In a non-limiting example, computing device 200 may rank a keyword such as “software engineering” found in user query 204 above remaining keywords based on a close match between “software engineering” keyword and the candidate's resume indicating that the candidate is a “software engineer”. Person of ordinary skill in the art, upon reviewing the entirety of this disclosure, will be aware of the various embodiments of ranking keywords for a search engine in the context of staffing and recruiting.

With continued reference to FIG. 2, computing device 200 may be configured to identify a job posting 232 as a function of keyword ranking 224 and user query 204. A “job posting,” as used in this disclosure, is any posting as described herein wherein the posting includes a job opening. In a non-limiting embodiment, computing device 200 may identify a plurality of job openings 232 based on keyword ranking 224 by retrieving them from a posting database 228. A “posting database,” as used in this disclosure, is any database used to store any job postings created and/or entered by an employer interacting with the apparatus of the present disclosure. In a non-limiting embodiment, computing device 200 may identify job posting 232 based on the job posting's posting score datum 156. For instance, each job posting may be ranked differently, wherein one job posting containing a role for “software engineering” is better than another job posting of the same role. Each job posting may be scored and identified to a candidate based on the candidate's score and the job posting's score. Person of ordinary skill in the art, upon reviewing the entirety of this disclosure, will be aware of the various embodiments of a metric system for job postings in the context of staffing and recruiting.

With continued reference to FIG. 2, job posting 200 may include a requirement identifier 236 and/or a plurality of requirement identifiers 236. A “requirement identifier,” as used in this disclosure, is an identifier of a job posting describing the contents of the job posting. In a non-limiting embodiment, requirement identifier 236 may include job description, duties, responsibilities, years of experience required, educational requirements, credential requirements, salary, benefits, location, employment type, or the like thereof. In some non-limiting embodiments, computing device 200 may also score and/or rank each requirement identifier 236 similarly to user identifier 108. Computing device 200 may generate a job posting's posting score datum 156 based on the scores and/or ranks of the job posting's requirement identifier 232. Person of ordinary skill in the art, upon reviewing the entirety of this disclosure, will be aware of the various embodiments of ranking and scoring job postings in the context of staffing and recruiting.

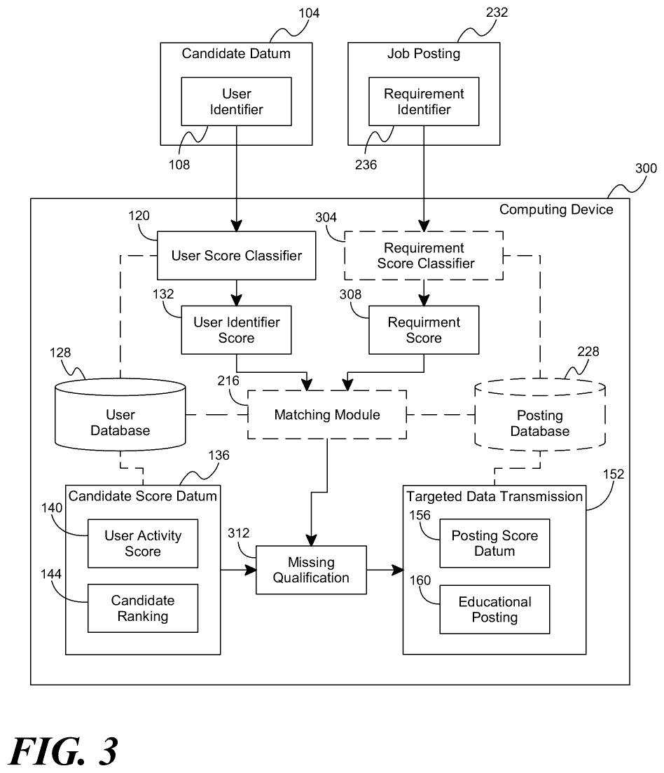

Now referring to FIG. 3, a block diagram of an apparatus for targeted advertising based on identified missing job qualifications according to another embodiment of the present invention is illustrated. Computing device 300 may be configured to match user identifiers 108 to requirement identifiers 236. Computing device 300 may be consistent with any computing device as described herein. In a non-limiting embodiment, computing device 300 may use matching module 216 to match user identifiers 108 and requirement identifiers 236. In some non-limiting embodiments, computing device 300 may also compute a requirement score 308 for requirement identifier 236 using a requirement score classifier. A “requirement score,” as used in this disclosure, is a quantitative symbol grading a job posting and its requirement identifiers based on a grading metric. The grading metric can include certain threshold, values, minimum requirements, and/or standard rubric. In some non-limiting embodiments, computing device 300 may compute a score based on other job postings and their requirement identifiers from posting database 228. In a non-limiting embodiment, requirement score 308 may include a grade, rating, percentage, percentile, value, or the like thereof, indicating a level of proficiency, preferability, and/or probability of success of finding a candidate for each requirement identifier 236. A “requirement score classifier,” as used in this disclosure, is any classifier as described herein used to output a requirement score using one or more requirement identifiers 236 as an input. In some non-limiting embodiments, computing device 300 may use matching module 216 to receive user identifier score 132 and requirement score 308 as inputs. Matching module 216 may also receive user identifiers 108 and requirement identifiers 236 as inputs.

With continued reference to FIG. 3, computing device 300 may be configured to identify at least a missing qualification 312 as a function of the match and/or matches from matching module 216. A “missing qualification,” as used in this disclosure, is a discrepancy found between a candidate datum and a job posting or a missing element found in the candidate datum in relation to a job posting. In a non-limiting embodiment, missing qualification 312 may be a lacking user identifier. For instance, a candidate may be a software engineer with a resume containing a plurality of user identifiers indicating the candidate is experienced with programming in “Python”. Computing device 300 may identify a job posting for the candidate wherein the job posting contains requirement identifiers indicating that the role for the job posting requires a candidate to be proficient in the “C++.” The lack of a user identifier denoting “C++” in the candidate's resume may be considered a missing qualification. Person of ordinary skill in the art, upon reviewing the entirety of this disclosure, will be aware of the various embodiments of a missing qualification for purposes as described herein.

With continued reference to FIG. 3, computing device 300 may provide targeted data transmission 152, wherein a posting from targeted data transmission 152 may satisfy missing qualification 312. For instance, although a job posting presented to a candidate requires proficiency in “C++” despite a candidate not having that experience, the employer behind that job posting May still select the candidate, in which case the candidate will then be able to fill that missing “C++ qualification.” In another example, computing device 300 may provide educational posting 160, such that the educational posting contains an online course about learning “C++” that the candidate may complete to satisfy the missing “C++” qualification. Once missing qualification 312 is satisfied, computing device 300 may update a candidate's profile and/or ranking such as candidate ranking 144. Person of ordinary skill in the art, upon reviewing the entirety of this disclosure, will be aware of the various embodiments of targeted advertisement in the context of satisfying missing qualifications.

Referring now to FIG. 4, is a graph illustrating an exemplary relationship between fuzzy sets 400. The graph may represent the fuzzy set inference system as described in FIG. 1. A first fuzzy set 404 may be represented, without limitation, according to a first membership function 408 representing a probability that an input falling on a first range of values 412 is a member of the first fuzzy set 404, where the first membership function 408 has values on a range of probabilities such as without limitation the interval [0,1], and an area beneath the first membership function 408 may represent a set of values within first fuzzy set 404. Although first range of values 412 is illustrated for clarity in this exemplary depiction as a range on a single number line or axis, first range of values 412 may be defined on two or more dimensions, representing, for instance, a Cartesian product between a plurality of ranges, curves, axes, spaces, dimensions, or the like. First membership function 408 may include any suitable function mapping first range 412 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 4, first fuzzy set 404 may represent any value or combination of values as described above, including output from one or more machine-learning models such as output datum from classifier 144 containing a matched user identifier. A second fuzzy set 416, which may represent any value which may be represented by first fuzzy set 404, may be defined by a second membership function 420 on a second range 424; second range 424 may be identical and/or overlap with first range 412 and/or may be combined with first range via Cartesian product or the like to generate a mapping permitting evaluation overlap of first fuzzy set 404 and second fuzzy set 416. Where first fuzzy set 404 and second fuzzy set 416 have a region 428 that overlaps, first membership function 408 and second membership function 420 may intersect at a point 432 representing a probability, as defined on probability interval, of a match between first fuzzy set 404 and second fuzzy set 416. Alternatively or additionally, a single value of first and/or second fuzzy set may be located at a locus 436 on first range 412 and/or second range 424, where a probability of membership may be taken by evaluation of first membership function 408 and/or second membership function 420 at that range point. A probability at 428 and/or 432 may be compared to a threshold 440 to determine whether a positive match is indicated. Threshold 440 may, in a non-limiting example, represent a degree of match between first fuzzy set 404 and second fuzzy set 416, and/or single values therein with each other or with either set, which is sufficient for purposes of the matching process; for instance, threshold may indicate a sufficient degree of overlap between a user identifier from a candidate and another identifier from a database of candidate information for combination to occur as described above. Alternatively or additionally, each threshold may be tuned by a machine-learning and/or statistical process, for instance and without limitation as described in further detail below.

Further referring to FIG. 4, in an embodiment, a degree of match between fuzzy sets may be used to classify user identifiers and/or candidates to rank them. In some cases, classifiers may user a standard metric to measure degrees of overlap and place each user identifier into a ranking. In another embodiment, user identifiers may be matched with requirement identifiers from job postings to find a degree of match between fuzzy sets representative of each identifier. Where multiple fuzzy matches are performed, degrees of match for each respective fuzzy set may be computed and aggregated through, for instance, addition, averaging, or the like, to determine an overall degree of match.

Still referring to FIG. 4, a computing device may use a logic comparison program, such as, but not limited to, a fuzzy logic model to determine a superiority ranking among the plurality of matched user identifiers and/or requirement identifiers. Membership function coefficients and/or constants may be tuned according to classification and/or clustering algorithms. For instance, and without limitation, a clustering algorithm may determine a Gaussian or other distribution of questions about a centroid corresponding to a given superiority level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 4, an inference engine may be implemented according to input and/or output membership functions and/or linguistic variables. For instance, a first linguistic variable may represent a first measurable value pertaining to input element of matched user identifier, such as a degree of compatibility of an element of matched user identifier to posting data, while a second membership function may indicate a degree of relevance of a subject thereof, or another measurable value pertaining to a matched requirement identifier. Continuing the example, an output linguistic variable may represent, without limitation, a score value. An inference engine may combine rules, such as: “if the compatibility level is ‘high’ and the relevance level is ‘high’, the superiority score to the posting data is ‘high’—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

Referring now to FIG. 5, an exemplary embodiment of a cryptographic accumulator 500 is illustrated. A “cryptographic accumulator,” as used in this disclosure, is a data structure created by relating a commitment, which may be smaller amount of data that may be referred to as an “accumulator” and/or “root,” to a set of elements, such as lots of data and/or collection of data, together with short membership and/or nonmembership proofs for any element in the set. In an embodiment, these proofs may be publicly verifiable against the commitment. An accumulator may be said to be “dynamic” if the commitment and membership proofs can be updated efficiently as elements are added or removed from the set, at unit cost independent of the number of accumulated elements; an accumulator for which this is not the case may be referred to as “static.” A membership proof may be referred to as a as a “witness” whereby an element existing in the larger amount of data can be shown to be included in the root, while an element not existing in the larger amount of data can be shown not to be included in the root, where “inclusion” indicates that the included element was a part of the process of generating the root, and therefore was included in the original larger data set. Cryptographic accumulator 500 has a plurality of accumulated elements 504, each accumulated element 504 generated from a lot of the plurality of data lots. Accumulated elements 504 are create using an encryption process, defined for this purpose as a process that renders the lots of data unintelligible from the accumulated elements 504; this may be a one-way process such as a cryptographic hashing process and/or a reversible process such as encryption. Cryptographic accumulator 500 further includes structures and/or processes for conversion of accumulated elements 504 to root 512 element. For instance, and as illustrated for exemplary purposes in FIG. 5, cryptographic accumulator 500 may be implemented as a Merkle tree and/or hash tree, in which each accumulated element 504 created by cryptographically hashing a lot of data. Two or more accumulated elements 504 may be hashed together in a further cryptographic hashing process to produce a node 508 element; a plurality of node 508 elements may be hashed together to form parent nodes 508, and ultimately a set of nodes 508 may be combined and cryptographically hashed to form root 512. Contents of root 512 may thus be determined by contents of nodes 508 used to generate root 512, and consequently by contents of accumulated elements 504, which are determined by contents of lots used to generate accumulated elements 504. As a result of collision resistance and avalanche effects of hashing algorithms, any change in any lot, accumulated element 504, and/or node 508 is virtually certain to cause a change in root 512; thus, it may be computationally infeasible to modify any element of Merkle and/or hash tree without the modification being detectable as generating a different root 512. In an embodiment, any accumulated element 504 and/or all intervening nodes 508 between accumulated element 504 and root 512 may be made available without revealing anything about a lot of data used to generate accumulated element 504; lot of data may be kept secret and/or demonstrated with a secure proof as described below, preventing any unauthorized party from acquiring data in lot.

Alternatively or additionally, and still referring to FIG. 5, cryptographic accumulator 500 may include a “vector commitment” which may act as an accumulator in which an order of elements in set is preserved in its root 512 and/or commitment. In an embodiment, a vector commitment may be a position binding commitment and can be opened at any position to a unique value with a short proof (sublinear in the length of the vector). A Merkle tree may be seen as a vector commitment with logarithmic size openings. Subvector commitments may include vector commitments where a subset of the vector positions can be opened in a single short proof (sublinear in the size of the subset). Persons skilled in the art, upon reviewing the entirety of this disclosure, will be aware of various alternative or additional cryptographic accumulators 500 that may be used as described herein. In addition to Merkle trees, accumulators may include without limitation RSA accumulators, class group accumulators, and/or bi-linear pairing-based accumulators. Any accumulator may operate using one-way functions that are easy to verify but infeasible to reverse, i.e. given an input it is easy to produce an output of the one-way function, but given an output it is computationally infeasible and/or impossible to generate the input that produces the output via the one-way function. For instance, and by way of illustration, a Merkle tree may be based on a hash function as described above. Data elements may be hashed and grouped together. Then, the hashes of those groups may be hashed again and grouped together with the hashes of other groups; this hashing and grouping may continue until only a single hash remains. As a further non-limiting example, RSA and class group accumulators may be based on the fact that it is infeasible to compute an arbitrary root of an element in a cyclic group of unknown order, whereas arbitrary powers of elements are easy to compute. A data element may be added to the accumulator by hashing the data element successively until the hash is a prime number and then taking the accumulator to the power of that prime number. The witness may be the accumulator prior to exponentiation. Bi-linear paring-based accumulators may be based on the infeasibility found in elliptic curve cryptography, namely that finding a number k such that adding P to itself k times results in Q is impractical, whereas confirming that, given 4 points P, Q, R, S, the point, P needs to be added as many times to itself to result in Q as R needs to be added as many times as possible to itself to result in S, can be computed efficiently for certain elliptic curves.

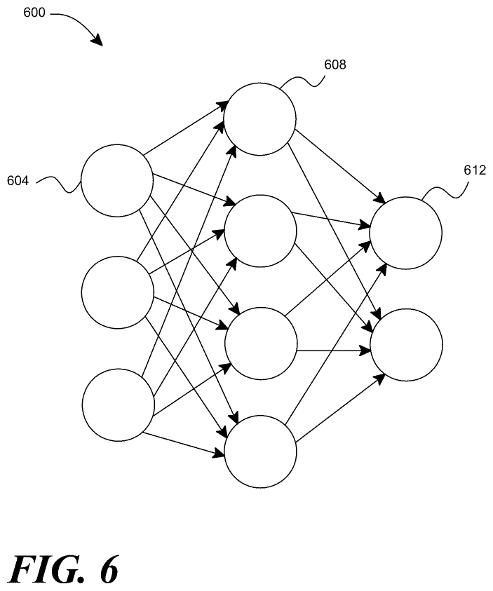

Referring now to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. In a non-limiting embodiment, nodes may represent candidates and employers as described herein. Such nodes may be organized in a network, such as without limitation a convolutional neural network, including an input layer of nodes 604, one or more intermediate layers 608, and an output layer of nodes 612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

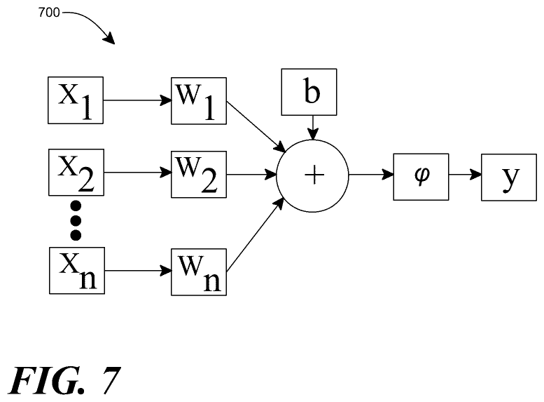

Referring now to FIG. 7, an exemplary embodiment of a node of a neural network is illustrated. A node may include, without limitation a plurality of inputs x, that may receive numerical values from inputs to a neural network containing the node and/or from other nodes. Node may perform a weighted sum of inputs using weights wᵢ, that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ, applied to an input x, may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, may be determined by training a neural network using training data, which may be performed using any suitable process as described above.

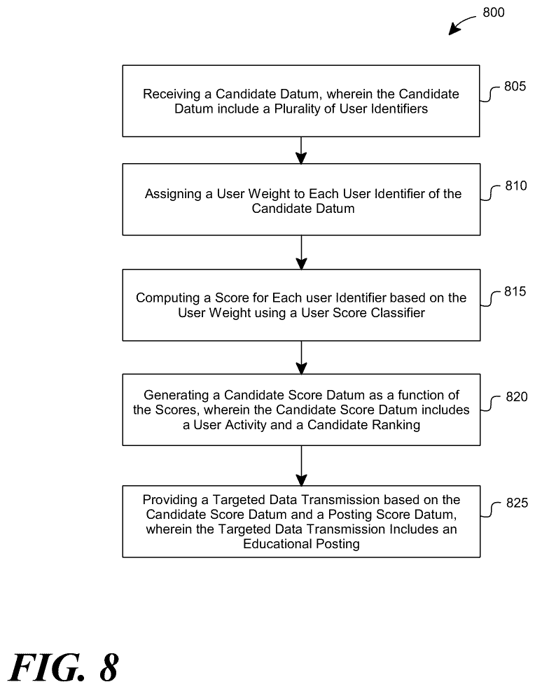

Now referring to FIG. 8, a flow diagram of an exemplary embodiment of a method 800 for targeted advertising based on identified missing job qualification is illustrated. At step 805, method 800 includes receiving, by at least a processor connected to a memory containing instructions for the at least a processor, a candidate datum, wherein the candidate datum contains a plurality of user identifiers describing a user. The at least a processor and the memory may be incorporated in a computing device as described herein. The candidate datum may be consistent with any candidate datum as described herein in the entirety of this disclosure. The user identifiers may be consistent with any user identifier as described herein. In a non-limiting embodiment, method 800 may include generating a candidate profile as a function of user inputs. The candidate profile may include any candidate profile as described herein. Person of ordinary skill in the art, upon reviewing the entirety of this disclosure, will be aware of the various embodiments of receiving candidate information for purposes as described herein.

In some non-limiting embodiments and still referring to FIG. 8, method 800 may include receiving a user query, wherein the user query comprises at least a keyword describing a job preference quality. The user query may include any user query as described herein. The at least a keyword may include any keyword as described herein. In a non-limiting embodiment, method 800 may include recording every user query and/or keyword into a query database. The query database may include any keyword database as described herein. Person of ordinary skill in the art, upon reviewing the entirety of this disclosure, will be aware of the various embodiments of receiving user input in the context of search engines.

Still referring to FIG. 8, at step 810, method 800 includes assigning a user weight to each user identifier of the candidate datum. The user weight may be consistent with any user weight as described herein. In a non-limiting embodiment, method 800 may include receiving the candidate datum and/or the user identifiers and parsing them using a language processing module. The language processing module may include any language processing module as described herein. In some non-limiting embodiments, assigning the user weights may include parsing the user identifiers and comparing them to other user identifiers stored in a user database. The user database may include any user database as described herein. Person of ordinary skill in the art, upon reviewing the entirety of this disclosure, will be aware of the various embodiments of parsing data and assigning a numerical value to it for purposes as described herein.

In some non-limiting embodiments and still referring to FIG. 8, method 800 may include assigning a query weight based on the at least a keyword of the user query. The query weight may include any query weight as described herein. In a non-limiting embodiment, method 800 may include assigning the query weight based on a parse as a function of the language processing module. In another non-limiting embodiment, assigning the query weight may include comparing the user query and/or the at least a keyword with other user queries and keywords inputted by other candidates and recorded into the query database. Person of ordinary skill in the art, upon reviewing the entirety of this disclosure, will be aware of the assigning a numerical value onto a user input for purposes as described herein.

Still referring to FIG. 8, at step 815, method 800 includes computing a score for each user identifier based on the user weight using a user score classifier The score may include a user identifier score, wherein the user identifier score may be consistent with any user identifier score as described in the entirety of this disclosure. The user score classifier may include any user score classifier as described herein. At step 815, method 800 further includes training the user score classifier using a user score training set, wherein the user score training set comprises an identifier significance correlated to a predictive score and outputting the scores as a function of the user score training set and the user weight and/or candidate datum as inputs. Person of ordinary skill in the art, upon reviewing the entirety of this disclosure, will be aware of the various embodiments of computing a score using machine-learning for purposes as described herein.

In some non-limiting embodiments and still referring to FIG. 8, method 800 may include matching the at least a keyword to the plurality of user identifiers of the candidate datum. In a non-limiting embodiment, matching may include using a matching module to compare and/or match user identifiers to keywords with consideration of the user weights and the query weights. Method 800 may further include generating a keyword ranking based on a plurality of weighted values based on the frequency of each keyword from a query database. The keyword ranking may include any keyword ranking as described herein. Person of ordinary skill in the art, upon reviewing the entirety of this disclosure, will be aware of the various embodiments of comparing user inputs and user information in the context of employment seeking.

Still referring to FIG. 8, at step 820, method 800 includes generating a candidate score datum as a function of the scores, wherein the candidate score datum comprises a user activity score based on a user interaction data of the user and a candidate ranking, wherein the candidate ranking is relative to a plurality of candidate score datums of other users from a user database. The candidate score datum may be consistent with any candidate score datum as described in the entirety of this disclosure. The interaction data may include any interaction data as described herein. The candidate ranking may include any candidate ranking as described herein. Person of ordinary skill in the art, upon reviewing the entirety of this disclosure, will be aware of the various embodiments of quantitatively assessing candidates in the context of recruitment.

In some non-limiting embodiments and still referring to FIG. 8, method 800 may include identifying a job posting as a function of the keyword ranking and the user query, wherein the job posting comprises a plurality of requirement identifiers. The job posting may include any job posting as described herein. The requirement identifiers may include any requirement identifiers as described herein. Method 800 may further include matching the plurality of user identifiers to the plurality of requirement identifiers and identifying at least a missing qualification in the candidate datum as a function of the match. Person of ordinary skill in the art, upon reviewing the entirety of this disclosure, will be aware of the various embodiments of identifying missing qualifications in the context of ranking and providing advertisements.

Still referring to FIG. 8, at step 825, method 800 includes providing a targeted data transmission based on the candidate score datum and a posting score datum, wherein the targeted data transmission comprises an educational posting. The targeted data transmission may include any targeted data transmission as described herein. The posting score datum may include any posting score datum as described herein. In some non-limiting embodiments, method 800 may include providing the targeted data transmission as a function of a notification. The targeted data transmission may contain educational postings, wherein the educational posting may include any educational posting as described herein and/or related job postings that may be beneficial to the candidate. Person of ordinary skill in the art, upon reviewing the entirety of this disclosure, will be aware of the various embodiments of postings that may be provided to a candidate in the context of targeted advertisements.

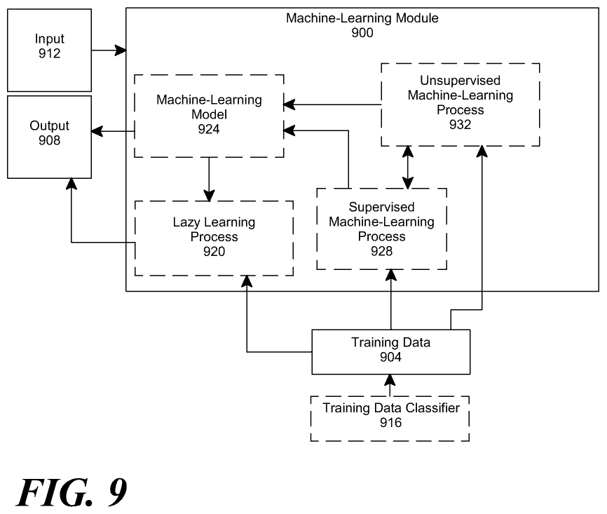

Referring now to FIG. 9, an exemplary embodiment of a machine-learning module 900 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 904 to generate an algorithm that will be performed by a computing device/module to produce outputs 908 given data provided as inputs 912; this is in contrast to a non-machine learning software program where the commands to be executed are determined in advance by a user and written in a programming language.

Still referring to FIG. 9, “training data,” as used herein, is data containing correlations that a machine-learning process may use to model relationships between two or more categories of data elements. For instance, and without limitation, training data 904 may include a plurality of data entries, each entry representing a set of data elements that were recorded, received, and/or generated together; data elements may be correlated by shared existence in a given data entry, by proximity in a given data entry, or the like. Multiple data entries in training data 904 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 904 according to various correlations; correlations may indicate causative and/or predictive links between categories of data elements, which may be modeled as relationships such as mathematical relationships by machine-learning processes as described in further detail below. Training data 904 may be formatted and/or organized by categories of data elements, for instance by associating data elements with one or more descriptors corresponding to categories of data elements. As a non-limiting example, training data 904 may include data entered in standardized forms by persons or processes, such that entry of a given data element in a given field in a form may be mapped to one or more descriptors of categories. Elements in training data 904 may be linked to descriptors of categories by tags, tokens, or other data elements; for instance, and without limitation, training data 904 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 9, training data 904 may include one or more elements that are not categorized; that is, training data 904 may not be formatted or contain descriptors for some elements of data. Machine-learning algorithms and/or other processes may sort training data 904 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 904 to be made applicable for two or more distinct machine-learning algorithms as described in further detail below. Training data 904 used by machine-learning module 900 may correlate any input data as described in this disclosure to any output data as described in this disclosure. As a non-limiting illustrative example, a user identifier may be an input and a user identifier score may be an output. In another non-limiting example, a requirement identifier may be an input and a requirement score may be an output.

Further referring to FIG. 9, training data may be filtered, sorted, and/or selected using one or more supervised and/or unsupervised machine-learning processes and/or models as described in further detail below; such models may include without limitation a training data classifier 916. Training data classifier 916 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 900 may generate a classifier using a classification algorithm, defined as a processes whereby a computing device and/or any module and/or component operating thereon derives a classifier from training data 904. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 916 may classify elements of training data to assign a ranking and/or placement of a candidate among other candidates or job postings among other job postings for which a subset of training data may be selected.

Still referring to FIG. 9, machine-learning module 900 may be configured to perform a lazy-learning process 920 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 904. Heuristic may include selecting some number of highest-ranking associations and/or training data 904 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 9, machine-learning processes as described in this disclosure may be used to generate machine-learning models 924. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 924 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 924 may be generated by creating an artificial neural network, such as a convolutional neural network comprising an input layer of nodes, one or more intermediate layers, and an output layer of nodes. Connections between nodes may be created via the process of “training” the network, in which elements from a training data 904 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 9, machine-learning algorithms may include at least a supervised machine-learning process 928. At least a supervised machine-learning process 928, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include any inputs as described above as inputs, any outputs as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 904. Persons skilled in the art, upon reviewing the entirety of this disclosure, will be aware of various possible variations of at least a supervised machine-learning process 928 that may be used to determine relation between inputs and outputs. Supervised machine-learning processes may include classification algorithms as defined above.

Further referring to FIG. 9, machine learning processes may include at least an unsupervised machine-learning processes 932. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 9, machine-learning module 900 may be designed and configured to create a machine-learning model 924 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 9, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

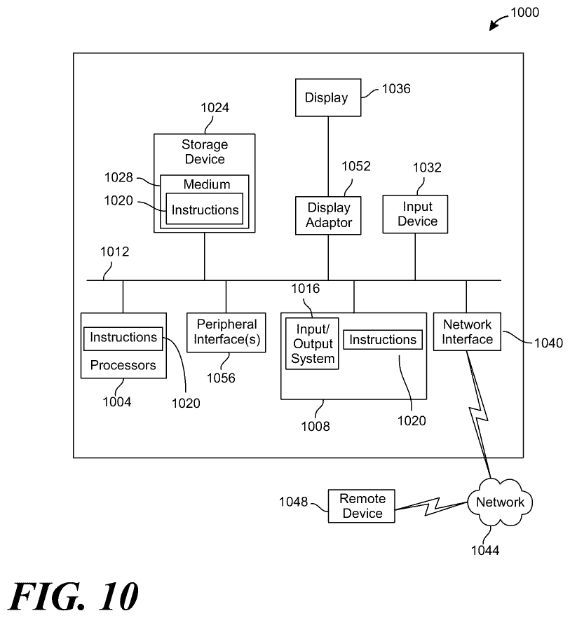

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for targeted advertising based on identified missing job qualifications, the apparatus comprising:
at least a processor; and
a memory communicatively connected to the at least a processor, the memory containing instructions configuring the at least a processor to:
receive a candidate datum from an immutable sequential listing, wherein the candidate datum comprises a plurality of user identifiers describing a user;
parse the candidate datum using a language processing module, wherein parsing the candidate datum comprises:
generating a language processing model, wherein the language processing model is generated by producing associations between one or more words extracted from at least a document and is configured to detect associations between such words, wherein generating the language processing model further comprises:
using a natural language processing classification algorithm by iteratively optimizing an objective function that represents a statistical estimation of relationships between input terms and output terms in a form of a sum of relationships to be estimated; and
inputting the candidate datum comprising the plurality of user identifiers to the language processing model to output resultant terms associated with the candidate datum;
assign a user weight to each user identifier of the candidate datum based on at least the outputted results of parsing the candidate datum comprising the plurality of user identifiers;
compute a score for each user identifier based on the user weight using a user score classifier, wherein the at least a processor is configured to:
train the user score classifier using a user score training set, wherein the user score training set comprises an identifier significance correlated to a predictive score, wherein training the user score classifier comprises:
iteratively updating the user score training set as a function of input and output results of the user score classifier; and
retraining the user score classifier with the updated user score training set; and
output the scores as a function of the updated user score training set;
generate a candidate score datum as a function of the scores, wherein the candidate score datum comprises:
a user activity score based on a user interaction data of the user, wherein the user interaction data comprises a frequency at which the user interacts with a website; and
a candidate ranking, wherein the candidate ranking is relative to a plurality of candidate score datums of other users from a user database; and
provide a targeted data transmission based on the candidate score datum and a posting score datum, wherein the targeted data transmission comprises an educational posting.

2. The apparatus of claim 1, wherein the memory contains instructions further configuring the at least a processor to:
receive a user query, wherein the user query comprises at least a keyword describing a job preference quality;
assign a query weight based on the at least a keyword of the user query;
match the at least a keyword to the plurality of user identifiers of the candidate datum;
generate a keyword ranking based on a plurality of weighted values based on the frequency of each keyword from a query database; and
identify a job posting as a function of the keyword ranking and the user query, wherein the job posting comprises a plurality of requirement identifiers.

3. The apparatus of claim 2, wherein the at least a processor is further configured to:
match the plurality of user identifiers to the plurality of requirement identifiers;
identify at least a missing qualification in the candidate datum as a function of the match; and
provide the targeted data transmission, wherein the educational posting of the targeted data transmission is configured to satisfy the at least a missing qualification.

4. The apparatus of claim 2, wherein the memory contains instructions further configuring the at least a processor to:
compute a requirement score for each requirement identifier;
generate the posting score datum based on the computed requirement scores; and
provide the targeted data transmission based on the posting score datum.

5. The apparatus of claim 2, wherein the at least a processor is further configured to provide a transition job posting datum based on the user query in an event the user query contains keywords distinct from the user identifiers.

6. The apparatus of claim 1, wherein the educational posting comprises an educational course wherein the at least a processor is further configured to update the candidate score datum as a function of the user completing the educational course.

7. (canceled)

8. The apparatus of claim 1, wherein the candidate ranking is generated using a fuzzy set inference system.

9. The apparatus of claim 1, wherein the targeted data transmission is provided as a function of a notification.

10. The apparatus of claim 1, wherein the targeted data transmission further comprises a job posting related to the candidate datum.

11. A method for targeted advertising based on identified missing job qualifications, the method comprising:
receiving, by at least a processor connected to a memory containing instructions for the at least a processor, a candidate datum from an immutable sequential listing,
wherein the candidate datum comprises a plurality of user identifiers describing a user;
parsing the candidate datum using a language processing module, wherein parsing the candidate datum comprises:
generating a language processing model, wherein the language processing model is generated by producing associations between one or more words extracted from at least a document and is configured to detect associations between such words, wherein generating the language processing model further comprises:
using a natural language processing classification algorithm by iteratively optimizing an objective function that represents a statistical estimation of relationships between input terms and output terms in a form of a sum of relationships to be estimated; and
inputting the candidate datum comprising the plurality of user identifiers to the language processing model to output resultant terms associated with the candidate datum;
assigning a user weight to each user identifier of the candidate datum based on at least the outputted results of parsing the candidate datum comprising the plurality of user identifiers;
computing a score for each user identifier based on the user weight using a user score classifier, wherein computing the score comprises:
training the user score classifier using a user score training set, wherein the user score training set comprises an identifier significance correlated to a predictive score, wherein training the user score classifier comprises:
iteratively updating the user score training set as a function of input and output results of the user score classifier; and
retraining the user score classifier with the updated user score training set; and
outputting the scores as a function of the updated user score training set;
generating a candidate score datum as a function of the scores, wherein the candidate score datum comprises:
a user activity score based on a user interaction data of the user, wherein the user interaction data comprises a frequency at which the user interacts with a website; and
a candidate ranking, wherein the candidate ranking is relative to a plurality of candidate score datums of other users from a user database; and
providing a targeted data transmission based on the candidate score datum and a posting score datum, wherein the targeted data transmission comprises an educational posting.

12. The method of claim 11, wherein the method further comprises:
receiving a user query, wherein the user query comprises at least a keyword describing a job preference quality;
assigning a query weight based on the at least a keyword of the user query;
matching the at least a keyword to the plurality of user identifiers of the candidate datum;
generating a keyword ranking based on a plurality of weighted values based on the frequency of each keyword from a query database; and
identifying a job posting as a function of the keyword ranking and the user query, wherein the job posting comprises a plurality of requirement identifiers.

13. The method of claim 12, wherein the method further comprises:
matching the plurality of user identifiers to the plurality of requirement identifiers;
identifying at least a missing qualification in the candidate datum as a function of the match; and
providing the targeted data transmission, wherein the educational posting of the targeted data transmission is configured to satisfy the at least a missing qualification.

14. The method of claim 12, wherein the method further comprises:
computing a requirement score for each requirement identifier;
generating the posting score datum based on the computed requirement scores; and
providing the targeted data transmission based on the posting score datum.

15. The method of claim 12, wherein providing the targeted data transmission further comprises providing a transition job posting datum based on the user query in an event the user query contains keywords distinct from the user identifiers.

16. The method of claim 11, wherein the educational posting comprises an educational course wherein the at least a processor is further configured to update the candidate score datum as a function of the user completing the educational course.

17. (canceled)

18. The method of claim 11, wherein generating the candidate ranking comprises generating the candidate ranking using a fuzzy set inference system.

19. The method of claim 11, wherein providing the targeted data transmission further comprises providing the targeted data transmission as a function of a notification.

20. The method of claim 11, wherein the targeted data transmission further comprises a job posting related to the candidate datum.
